(19) United States
(12) Patent Application Publication
(10) Pub. No.: US 2007/0043732 A1
(43) Pub. Date: Feb. 22, 2007

(54) Contact exporting

(76) Inventor: Christian Schleimer, Karlsruhe (DE)

Correspondence Address: FISH & RICHARDSON, P.C., PO BOX 1022, MINNEAPOLIS, MN, 55440-1022, US

(21) Appl. No.: 11/205,463

(22) Filed: Aug. 16, 2005

(51) Int. Cl. G06F 17/30

(52) U.S. Cl. 707/10

(57) ABSTRACT

Data containing contact information may be exported to a remote application by associating contact information data for a single contact with one of a plurality of database objects. After this association has occurred, contact information data and data identifying the database object may be transmitted over a communications network to the remote application in a form that enables the remote application, when initiating one or more machine-executable processes that use the database object and contact information data associated therewith, to make use of the transmitted contact information data in executing the processes. Related apparatuses, methods, systems, computer program products are also described.

### TECHNICAL FIELD

The subject matter described herein relates to the management of contact information data among heterogeneous applications.

### BACKGROUND

Companies are increasingly implementing enterprise resource planning (ERP) applications in order to more efficiently respond to various business requirements. ERP applications provide a large number of benefits including, the conversion of time-consuming, manual steps into streamlined, online processes to improve overall enterprise planning; support of planning and deployment of assets, management of assets over their complete life cycle; reduction of order cycle times and excess inventories; streamlined processes at warehouses and distribution facilities; more efficient management of transportation; extension of collaboration with customers and suppliers; enablement of a collaborative project management environment that includes external parties to manage both simple and complex projects; the provision of personalized interfaces, portals, mobile applications, and tools that enable employees to more effectively perform their jobs; enablement of enterprise wide visibility, forecasting, and performance management—reducing planning cycles and lead times; enablement of continuous process improvements and faster response to new opportunities; improved customer service and the ability to respond quickly to customer demand, and the like.

Most companies adopt ERP applications in connection with conventional business software. For example, an individual may receive e-mail messages, calendar meetings, and maintain his or her contacts using programs such as MS Outlook, Eudora, or an Internet-based e-mail account. In addition, in some companies, individuals use dedicated contact management applications such as ACT and Plaxo for their address books. While such e-mail and contact management applications are easy to use and require no additional training (as compared to ERP applications), they are typically not integrated with ERP applications. Therefore, circumstances may arise when an individual updates the contact information for a customer on his or her local computer which is not carried over to the various ERP applications.

For example, a customer, which is accustomed to interfacing with a salesperson, may e-mail the salesperson their new contact information in, for example, the form of a vcard (see RFCs 2425 and 2426). The salesperson might then update their local contact management application with this new information, but neglect to make the necessary changes in the applicable ERP applications (which may require manual entry of the contact information). Therefore, future transactions involving this customer may be disrupted due to the obsolete contact information associated with the ERP applications.

### SUMMARY

In one aspect, a computer-implemented method for exporting data containing contact information to a remote application may associate contact information data for a single contact (e.g., a vcard, etc.) with one of a plurality of database objects (e.g., a physical or logical object of significance to a business). Based on this association, contact information data and data identifying the database object may be transmitted over a communications network to the remote application. Such transmitted data may be in a form that enables the remote application, when initiating one or more machine-executable processes that use the database object and contact information data associated therewith, to make use of the transmitted contact information data in executing the processes.

In one variation, associating contact information data for a single contact with one of a plurality of database objects may comprise associating the contact information data with one of a plurality of database object categories, and associating the contact data with one of a plurality of database objects corresponding to the one of a plurality of database object categories. Additionally or in the alternative, the remote application may receive the contact information data and the data identifying the database object, and store the received contact information data and the data identifying the database object in a data repository associated with the remote application.

In order to associate contact information data with a database object and/or database object category, a graphical user interface may be provided. The graphical user interface may include one or more graphical user interface elements and be operable to display a list of database object categories (e.g., via a drop down menu, etc.), receive a selection of one of the database object categories, display a list of database objects corresponding to a selected database object category, and receive a selection of one of the database objects. Optionally, the graphical user interface may be operable to display a list of a plurality of remote applications coupled to a groupware application (e.g., a contact management system) and receive a selection of one of the plurality of remote applications. Once the remote application has been selected, database object categories and/or database objects may be displayed. In some implementations, the graphical user interface elements may be displayed, for example, in response to the receipt of a request to export contact information data to the remote application.

The contact information data may also be associated with database object categories and/or a database objects based on an e-mail address within the contact information data. In those cases in which the contact information data is appended to an e-mail message, the associated database object category and/or database object may be based on an e-mail address of an entity sending such message.

In yet another variation, messages received via a communications network are scanned to determine whether they contain contact information data. A notification (e.g., window, etc.) may be displayed indicating that contact information data has been received. A user may then be presented with a graphical user interface element (e.g., Contact detected; export YES/NO, etc.) to enable the export of the received contact information data. Additionally, or in the alternative, it may be periodically determined whether contact information data for a contact has been modified since a last transmission of data associated with the contact. If the contact information data has been modified, then the contact information data may be sent to a remote application associated with the last transmission and/or a user may be prompted to indicate whether they would like to export the modified contact information data.

In another aspect, an apparatus to export data containing contact information to a remote application may comprise an association unit and a transmitter. The association unit may be operable to associate contact information data for a single contact with one of a plurality of database objects. The transmission unit may be operable to transmit the contact information data and data identifying the database object over a communications network to the remote application in a form that enables the remote application, when initiating one or more machine-executable processes that use the database object and contact information data associated therewith, to make use of the transmitted contact information data in executing the processes.

In some variations, the transmitter may be coupled to a receiver (via, for example, a communications network) that is operable to receive the contact information data and the data identifying the database object. A data repository may store the received contact information data and the data identifying the database object.

In an interrelated aspect, it may be determined whether messages received via a communications network contain contact information data. This contact information data within the received messages may be associated with one or more database objects and/or one or more corresponding remote applications. Subsequently, for each database object, the contact information data associated with the database object and data that identifies the database object may be transmitted over the communications network to the corresponding associated remote application. The corresponding remote application may use this transmitted data to conduct one or more processes related to the database object.

In some variations of the interrelated aspect, the contact information data within the received messages may be associated with one or more database objects and one or more corresponding remote application by associating the contact information data with one of a plurality of database object categories, and associating the contact data with one of a plurality of database objects corresponding to the one of a plurality of database object categories. Moreover, in certain variations, received messages may be selectively filtered based on an e-mail address of the originator of the message and/or an e-mail address within the contact information data prior to the determination of whether messages received via a communications network contain contact information data.

Computer program products, tangibly embodied in information carriers are also described. Such computer program products may cause a data processing apparatus to conduct one or more operations described herein.

Similarly, systems are also described that may include a processor and a memory coupled to the processor. The memory may encode one or more programs that cause the processor to perform one or more of the method acts described herein.

The subject matter described herein provides many advantages. For example, the subject matter herein may be used to ensure that contact information data resident on one or more remote client contact management applications is also provided to one or more centralized ERP applications.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram for exporting data containing contact information to a remote application;

FIG. 2 is a schematic diagram of an apparatus operable to export data containing contact information to a remote application;

FIG. 3 is a process flow diagram for identifying contact information data in received messages and transmitting the contact information data to a remote application;

FIG. 4 is a schematic diagram of an apparatus operable to identify contact data in received messages and transmit the contact information data to a remote application; and

FIG. 5 is a schematic diagram of a groupware application coupled to an enterprise resource planning system useful for understanding and implementing the subject matter described herein.

### DETAILED DESCRIPTION

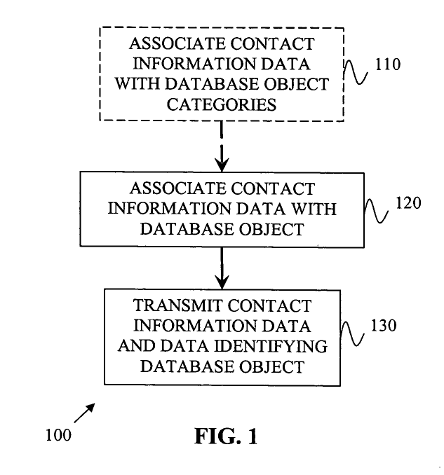

FIG. 1 illustrates a method 100 for exporting data containing contact information to a remote application. Contact information data for a single contact is associated, at 120, with one of a plurality of database objects. Based on this association, at 130, contact information data and data identifying the database object are transmitted over a communications network to the remote application. Such transmitted data may be in a form that enables the remote application, when initiating one or more machine-executable processes that use the database object and contact information data associated therewith, to make use of the transmitted contact information data in executing the processes. In some variations, the associating contact information data for a single contact with one of a plurality of database objects at 120 may be based on a preceding association, at 110, of the contact information data with one of a plurality of database object categories.

FIG. 2 illustrates an apparatus 200 to export data containing contact information to a remote application that comprises an association unit 210 and a transmitter 220. The association unit 210 is operable to associate contact information data for a single contact with one of a plurality of database objects. The transmission unit 220 is operable to transmit the contact information data and data identifying the database object over a communications network to the remote application. This transmitted data may be in a form that enables the remote application, when initiating one or more machine-executable processes that use the database object and contact information data associated therewith, to make use of the transmitted contact information data in executing the processes. Optionally, the apparatus 200 may be coupled to a remote application 230 (e.g., a node associated with the remote application 230).

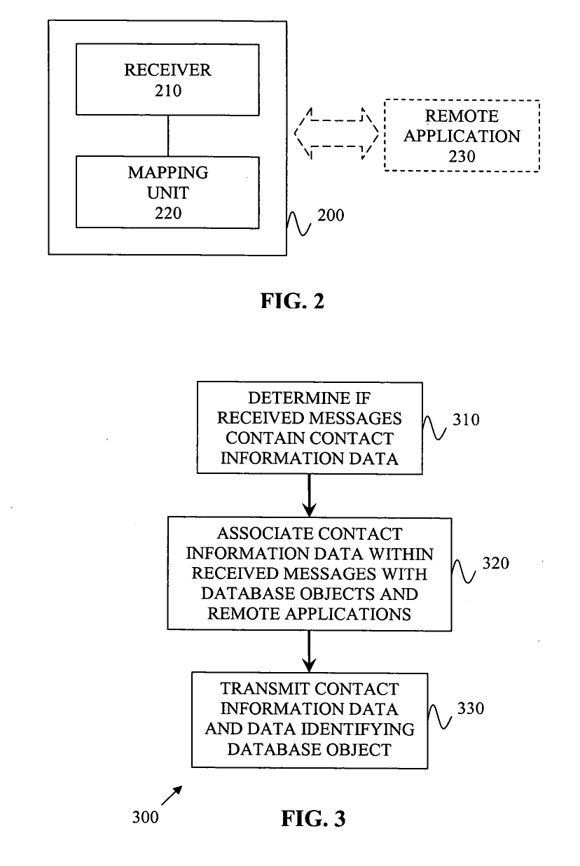

FIG. 3 illustrates a method 300 interrelated to the method 100 of FIG. 1. At 310, it is determined whether messages received via a communications network contain contact information data. At 320, contact information data within the received messages is associated with one or more database objects and one or more corresponding remote applications. Subsequently, at 330, for each database object, the contact information data associated with such database object and data identifying the database object is transmitted over the communications network to the corresponding associated remote application. This transmitted data may optionally be in a form that enables the corresponding remote application, when initiating one or more machine-executable process that uses the database object and contact information data associated therewith, to make use of the transmitted contact information data in executing the processes.

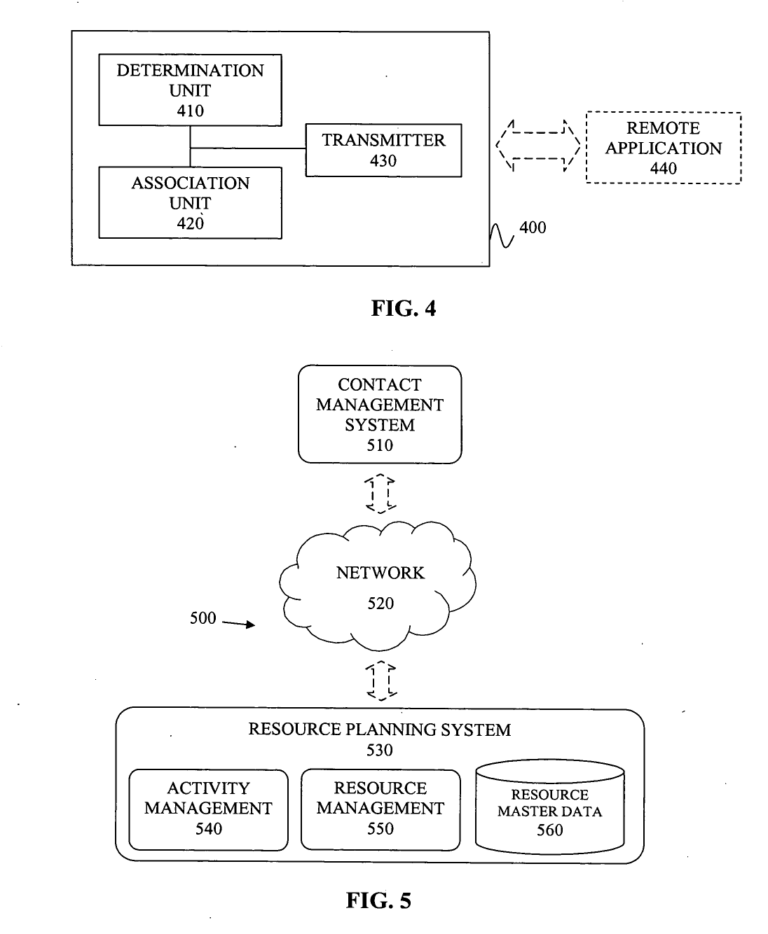

FIG. 4 illustrates an apparatus 400 interrelated to the apparatus 200 of FIG. 4 that comprises a determination unit 410, an association unit 420, and a transmitter 430. The determination unit 410 is operable to determine whether messages received via a communications network contain contact information data. The association unit 420 is operable to associate contact information data within the received messages with one or more database objects and one or more corresponding remote applications. The transmitter 430 is operable to transmit, for each database object, the contact information data associated with such database object and data identifying the database object over the communications network to the corresponding associated remote application. In some variations, the corresponding remote application may utilize the transmitted data when initiating one or more machine-executable process that uses the database object and contact information data associated therewith. Optionally, the apparatus 400 may be coupled to a remote application 440 (or a node associated with the remote application 440).

The following provides information useful for understanding and implementing the subject matter described herein as well as optional variations that may be implemented singly or in combination depending on the desired configuration.

FIG. 5 illustrates a system 500 in which a client-based contact management system 510, such as Outlook, Outlook Express, Eudora, NetMail, ACT, Plaxo, and the like, is used to create, edit, and other manage contact information data for a plurality of contacts (e.g., individuals, businesses, etc.). The contact management may be coupled to a resource planning system 530 via a network 520 (e.g., the Internet, a LAN, a WAN, and the like).

The resource planning system 530 may comprise an activity management unit 540, a resource management 550 unit, and a resource master data repository 560. The activity management unit 540 may associate, and/or obtain contact information data with an entry for a database object associated with the underlying contact in the resource master data repository 560. The database object represents a physical or logical object of significance to a business (e.g., a business object). The resource master data repository 560 may, for example, store contact information data (e.g., data in vcard format, etc.) for a plurality of contacts for one or more database objects.

The resource management unit 550 may perform resource various ERP type functions including the generation of invoices and purchase orders. With such transactions, the resource management unit 550 may obtain and utilize contact information data from the resource master data repository 560 for the various database objects involved with such activities. For example, the contact information data for a customer may be used to address an invoice and/or the contact information data for a supplier may be used to address a purchase order.

In one variation, a user of the contact management system 510 may select an option to export contact data by, for example, activating a graphical user interface element associated with a contact, selecting an export contact option from a drop down menu, activating a graphical user interface element (e.g., a button), and the like. Thereafter, the user may be presented with a list of database object categories (e.g., customer, supplier, buyer, etc.) in which to associate the contact. These database object categories may be generic in nature or they may be based on categories defined by the resource planning system 530 (and additionally other similar ERP applications). After a database object category is selected, a list of specifically identified database objects (e.g., if the database object is a customer, Advanced Widgets, Inc., Amalgamated Parts Corporation, etc.) associated with the database object category may be presented. Once the database object is selected, contact information data for the selected contact is then transmitted via the network 520 using an e-mail address (or other identifier) associated with the database object and/or the resource planning system 530 to the resource planning system 530. The resource planning system 530 may then update or contact data information for the database object in the resource master data repository 560.

In some variations, the contact management system 510 may poll the resource planning system 530 in order to determine a list of available database object categories as well as a list of available database objects in each of such categories. This polling may occur at periodic intervals, in response to the request to export data, each time the contact management system 510 is initially loaded, and the like.

In other variations, the contact management system 510 may comprise an integral e-mail program and/or be coupled to an e-mail program. With this arrangement, the contact management system 510 scans each incoming e-mail message in order to determine whether the message contains contact information data (e.g., an attachment in the vcard format, etc.) for a contact. If a message is detected that contains contact information data, the contact management system 510 may determine whether the contact information data differs from pre-existing data for the applicable contact. If the contact information data is different, the contact is associated with a database object at a remote application, such as the resource planning system 530. Thereafter, the contact information data (or a portion thereof) along with an identifier of the database object may be sent to the resource planning system 530. The resource planning system 530 may then update the information for the database object in the resource master data repository 560. [00341 Optionally, the contact management system 510 may only scan e-mail messages from certain senders (based, for example, on the name of the sender and/or the originating e-mail address). In addition or in the alternative, only changes to contact information data for certain contacts may be transmitted to the resource planning system 530. For example, only changes to contact information data for contacts having an e-mail address ending in sap.com would be transmitted to the resource planning system 530.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method for exporting data containing contact information to a remote application, the method comprising:
associating contact information data for a single contact with one of a plurality of database objects; and
transmitting the contact information data and data identifying the database object over a communications network to the remote application in a form that enables the remote application, when initiating one or more machine-executable processes that use the database object and contact information data associated therewith, to make use of the transmitted contact information data in executing the processes.

2. A method as in claim 1, wherein associating contact information data for a single contact with one of a plurality of database objects comprises:
associating the contact information data with one of a plurality of database object categories; and
associating the contact data with one of a plurality of database objects corresponding to the one of a plurality of database object categories

3. A method as in claim 1, further comprising:
receiving, by the remote application, the contact information data and the data identifying the database object; and
storing the received contact information data and the data identifying the database object in a data repository associated with the remote application.

4. A method as in claim 1, further comprising:
providing a graphical user interface that is operable to:
display a list of database object categories;
receive a selection of one of the database object categories;
display a list of database objects corresponding to a selected database object category; and
receive a selection of one of the database objects.

5. A method as in claim 1, further comprising: identifying the plurality of database objects based on an e-mail address within the contact information data.

6. A method as in claim 1, further comprising: determining if messages received via the communications network contain contact information data.

7. A method as in claim 1, further comprising:
receiving a request to export the contact information;
displaying a list of a plurality of remote applications coupled to a groupware application; and
receiving a selection of one of the plurality of remote applications.

8. A method as in claim 1, further comprising:
determining if messages received via a communications network contain contact information data;
displaying a notification that contact information data has been received; and
receiving a selection to export the received contact information data.

9. A method as in claim 1, further comprising:
periodically determining whether contact information data for a contact has been modified since a last transmission of data associated with the contact.

10. An apparatus to export data containing contact information to a remote application, the apparatus comprising:
an association unit to associate contact information data for a single contact with one of a plurality of database objects; and
a transmission unit to transmit the contact information data and data identifying the database object over a communications network to the remote application in a form that enables the remote application, when initiating one or more machine-executable processes that use the database object and contact information data associated therewith, to make use of the transmitted contact information data in executing the processes.

11. An apparatus as in claim 10, further comprising:
a receiver coupled to the transmitter via the communications network to receive the contact information data and the data identifying the database object; and
a data repository to store the received contact information data and the data identifying the database object.

12. An apparatus as in claim 10, further comprising:
a graphical user interface unit to:
display a list of database object categories;
receive a selection of one of the database object categories;
display a list of database objects corresponding to a selected database object category; and
receive a selection of one of the database objects.

13. An apparatus as in claim 10, further comprising: an identification unit to identify at least one of the plurality of database objects categories and the plurality of database objects based on an e-mail address within the contact information data.

14. An apparatus as in claim 10, further comprising:
a graphical user interface unit to:
receive a request to export the contact information;
display a list of a plurality of remote applications coupled to a groupware application; and
receive a selection of one of the plurality of remote applications.

15. An apparatus as in claim 10, further comprising:
a monitoring unit to determine if messages received via a communications network contain contact information data; and
a graphical user interface unit to display a notification that contact information data has been received and to receive a selection to export the received contact information data.

16. An apparatus as in claim 10, further comprising: an updating unit to periodically determine whether contact data information data for a contact has been modified since a last transmission of data associated with the contact.

17. A computer-implemented method comprising:
determining if messages received via a communications network contain contact information data;
associating contact information data within the received messages with one or more database objects and one or more corresponding remote applications; and
transmitting, for each database object, the contact information data associated with the database object and data identifying the database object over the communications network to the corresponding associated remote application in a form that enables the corresponding remote application, when initiating one or more machine-executable processes that uses the database object and contact information data associated therewith, to make use of the transmitted contact information data in executing the processes.

18. A method as in claim 17, wherein the associating contact information data within the received messages with one or more database objects and one or more corresponding remote application comprises:
associating the contact information data with one of a plurality of database object categories; and
associating the contact data with one of a plurality of database objects corresponding to the one of a plurality of database object categories.

19. A method as in claim 17, further comprising selectively filtering received messages based on an e-mail address of the originator of the message prior to the determining if messages received via a communications network contain contact information data.

20. A method as in claim 17, wherein the associating contact information data within the received messages with one or more database objects and one or more corresponding remote applications comprises identifying an e-mail address in the contact information data and associating the e-mail address with one or more database objects.
